(19) United States
(12) Patent Application Publication
(10) Pub. No.: US 2010/0205159 A1
(43) Pub. Date: Aug. 12, 2010

(54) SYSTEM AND METHOD FOR MANAGING DATA

(76) Inventors: Jun Li, Mountain View, CA (US); Bryan Stephonson, Alviso, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/368,777

(22) Filed: Feb. 10, 2009

(51) Int. Cl. G06F 17/30

(52) U.S. Cl. 707/694; 707/E17.009

(57) ABSTRACT

A system and method for managing data are presented herein. The system includes a plurality of data sets, a plurality of data access policies, and a policy enforcer. The plurality of data sets can be stored in a data store on a server. The data access policies can each be associated with a single data set and can be captured in a workflow template and encapsulated with the data set. At least one of the data policies can use human evaluation. The policy enforcer can be configured to receive requests for data, to interpret the associated data policy, and to comply with the human evaluation of the data policies by spawning a child workflow defined in the data policy to initiate the human evaluation across a network.

### BACKGROUND

Large numbers of consumers, businesses, and public entities are now using the Internet for a variety of transactions. This has enabled service providers to offer outsourcing capabilities to business customers using software-as-a-service delivery models in services marketplaces. However, challenges remain in widespread acceptance of such delivery models because they require customers to share business critical or sensitive information and data with the service providers.

### BRIEF DESCRIPTION OF THE DRAWINGS

FIG. 1 is block diagram of an overall system for data management, in accordance with an embodiment;

FIG. 2 is a flow diagram illustration of lifecycle management for a data management system, in accordance with an embodiment;

FIG. 3 is a flow chart of a child workflow to approve content appropriateness, in accordance with an embodiment;

FIG. 4 is a block diagram depicting event interactions when dealing with data management, in accordance with an embodiment; and

FIG. 5 is a flow chart of a method for managing data, in accordance with an embodiment.

### DETAILED DESCRIPTION OF EXAMPLE EMBODIMENTS

Reference will now be made to the exemplary embodiments illustrated, and specific language will be used herein to describe the same. It will nevertheless be understood that no limitation of the scope of the invention is thereby intended.

The technology industry is in the midst of a large shift that will likely transform how people access information, share content, and communicate. This wave is being driven by the large scale movement of consumers to find and use information over the Web. This has lead to businesses not only making content available over the Web, but also selling and delivering services over the web.

Challenges remain, however, to realize the vision of conducting business using services provided from service marketplaces. In particular, business customers are sensitive about sharing sensitive business information and data. Such data may include customer lists, sales data, product information, trade secrets, and/or financial data. While data handling policies can be specified in service level agreements or contracts, these contracts are usually written in legal terms and filed away from the actual data. Further, the contracts generally do not contain fine grained policies useful in managing data during day-to-day operations. Even when a service provider agrees to fine grained policies, it is possible for data to be mishandled inadvertently because multiple service providers are often involved in delivering any service. Thus, the presently-disclosed systems and methods recognize the importance of policy management frameworks that can be used in dynamic cross-organizational service provider environments, as well as mechanisms for ensuring that the data is appropriately protected and policies are followed.

A system and method for managing data are presented herein. The system includes a plurality of data sets, a plurality of data access policies, and a policy enforcer. The plurality of data sets can be stored in a data store or database on a server. The data access policies can each be associated with a single data set and can be captured in a workflow template and encapsulated with the data set. At least one of the data policies can use human evaluation. The state machine policy enforcer can be configured to receive requests for data, to interpret the associated data policy, and to comply with the human evaluation of the data policies by spawning a child workflow defined in the policy to initiate the human evaluation across a network. As used herein, data stores can include one or more of databases, file systems, content stores, and tape. In one embodiment, the data store comprises or consists essentially of one or more databases.

To elaborate further, in a shared service computing environment, a service can encapsulate multiple data sets, each of which represents an asset of one of the multiple tenants that are using the service. A data set can be a file directory, a single document, multi-media object, a database table, or other discrete amounts of digital data. At a finer granularity, for example, a data set can be a row in a database table that contains a piece of sensitive customer information imported from an external service, or a file that contains a particular marketing campaign brochure template.

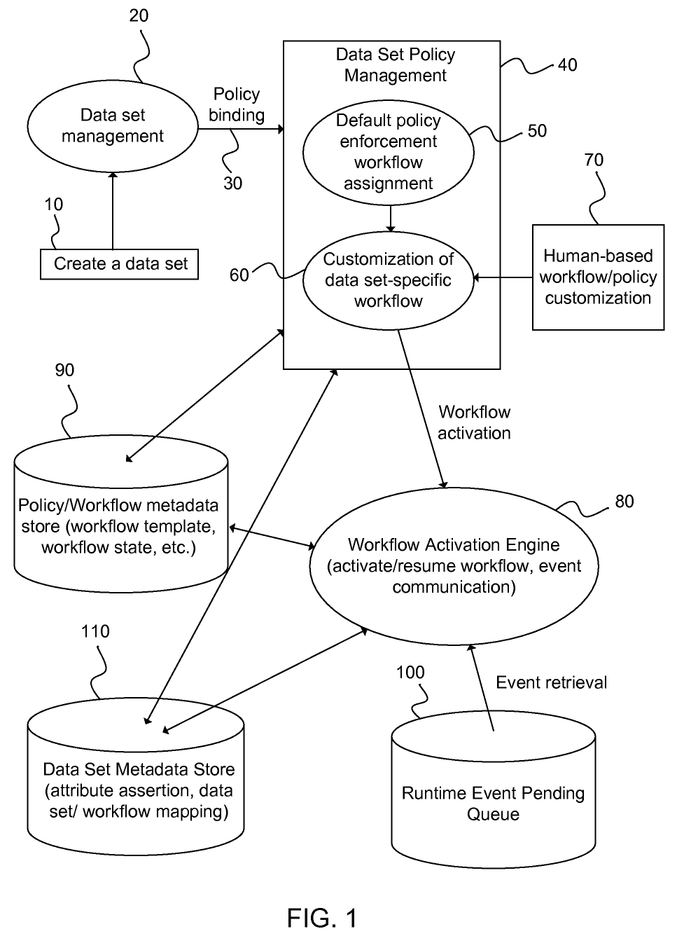

A high-level system architecture is illustrated in FIG. 1. A data set creation is requested 10 from the data set management service component 20. Once a data set is created, the policy binding request is issued 30 by the data set management component to the data policy management service component 40. A data policy is represented as a workflow description. A default policy enforcement workflow, which can encapsulate execution steps and rules, can be selected and attached to the data set just created 50. Optionally, one or more refinements of the policy enforcement workflow or data access policies may be assigned to the data set, as customization occurs 60. In one embodiment, several refinements of the policy enforcement workflow maybe assigned to the data set if the data matches certain rules already set in the data set policy management component, in order to achieve the customization of the data policy. The workflow can be further adjusted at this point in time or any other point in time during the life of the data set, by people, software programs, or both.

In one embodiment, the customization of the data set specific workflow (i.e., policy) can include human evaluation 70. Human evaluation can include any interaction with a person related to the review, evaluation, approval, etc., of the data set during a workflow. For example the human evaluation can include review and/or approval of data. Non-limiting examples of approval include determining content correctness, determining appropriateness for a particular usage, determining approval to migrate data, determining approval of migration specifications for the data, destruction of data, and combinations thereof In another embodiment, the human evaluation can include approval of receiving party or parties as appropriate for receiving requested data. Human evaluation can be carried out by one or more people. In the policies, the people can be identified as individuals, as persons belonging to certain groups, as individuals holding a specific job title, or any other means of identifying a particular person, either as an individual, or based on a role or title or other qualification.

A data set can potentially be associated with many policy enforcement workflows, or data access policies. Each chosen policy enforcement workflow or data access policy can be published to and then activated by the associated workflow activation engine 80. The workflow activation engine instantiates the workflow instance and manages the lifecycle of the workflow instance. Such management can include dehydration (i.e., to turn the running workflow instance into a piece of data following a well-defined format, and store this piece of data into a persistent store, such as a database) and hydration (i.e., to retrieve the corresponding data from a persistent store that represents a workflow instance, and then transform the data into an active workflow instance) of the workflow instance to and from the policy/workflow metadata store 90.

The engine retrieves pending runtime events from the runtime event pending queue 100, and raises the events to the corresponding active workflow instance. If the workflow instance is currently idle and suspended, the workflow can be activated from the dehydrated state before the events are raised to the workflow activation engine. The system can further include a data set metadata store 10 in communication with the workflow activation engine that includes attribute assertion, and data set workflow mapping.

The policy/workflow metadata store 90 can also store the data set specific workflow templates or data policies. When a data set is eventually removed, the associated data set policies will be terminated and then removed from the workflow activation engine 80. The corresponding metadata stored in the policy/workflow metadata store can be removed as well. The policy/workflow metadata store can allow for more efficient running of the workflow activation engine. In one embodiment, to allow a large number of simultaneous state machines to be managed, the workflow activation engine supports hydration and de-hydration such that a created state machine instance only resides in the runtime memory when a transition within it is triggered by an event.

Scalability of the overall system can be achieved by implementing the execution engine on a cluster, and attaching a message dispatcher to route the events or service responses to the appropriate node in the cluster. In one embodiment, as the workflow instances (i.e., the policy execution instances) are hydrated from the shared persistent storage within the cluster, and are de-hydrated when necessary, and any node in the computing cluster can handle any event or message.

The system disclosed herein allows data sets to be stored in the data store on the server controlled by a first party and at least one of the data sets maybe owned by a second party. For example, a service provider can host the data from multiple owners. In a further example, one party can store a plurality of data sets having data set-specific data policies in a common data store on a server. The service provider can further utilize services from sub-contractors. The hosting or storage can be configured in a manner that allows for strict compliance to owner-defined policies. Therefore, the data sets can include any amount or type of sensitive information.

A workflow (i.e., a policy) under the control of the workflow activation engine contains a state-machine as part of the policy description. This state-machine defined in the data policy is also called a state-machine based workflow. Each such state machine encodes the data set lifecycle related states, such as data set creation, data set update, data set read, and data set destroy, in such a way that lifecycle related policies can be encapsulated in the actions attached to the states. If the action is simple, such as data logging, the workflow execution engine can perform such action by itself. However, if the action is complex, especially when human evaluation is involved, such action is typically represented as another workflow, which is called a child workflow. Consequently, a policy is represented by a set of the workflows, with the state machine workflow as the top-level workflow, and possibly includes other child workflows to represent complex actions defined for the state transitions. It should be noted that a data set update may update the data set, the metadata about the data set, or both.

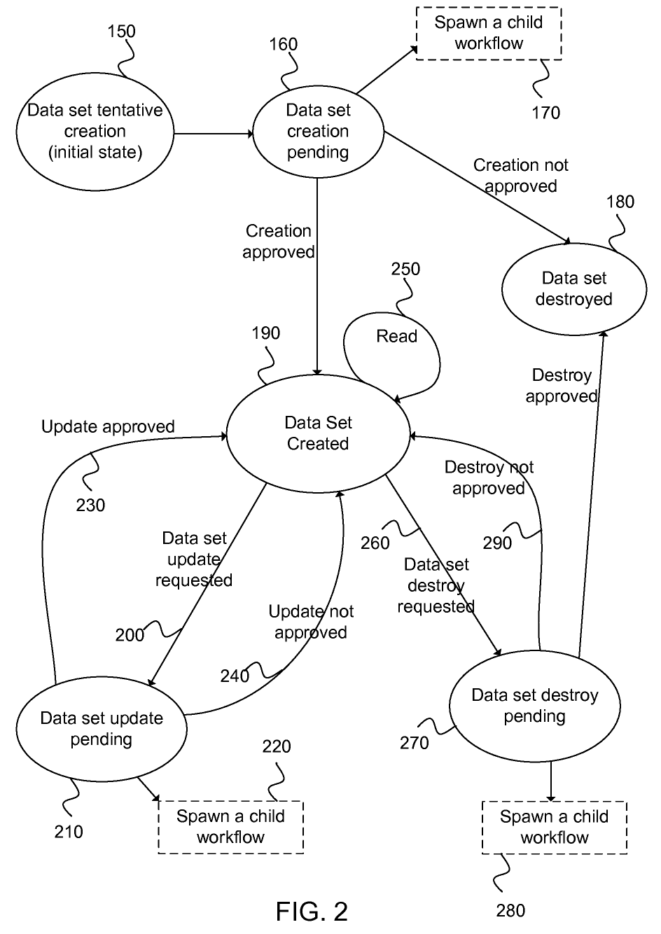

FIG. 2 illustrates approval-related lifecycle management for a content management service. As shown, an initial state is data set tentative creation 150. Data set creation pending 160 spawns a child workflow 170, whereupon creation is either approved or not approved. Where creation is not approved, the data set is destroyed. Where the creation is approved, the data set is created 190.

The data set can be updated, which includes a data set update request 200. While the data set update is pending 210, a child workflow 220 can be spawned to adhere to the policies previously set. If the update is approved, the data set can be appropriately updated 230. If however, the update is not approved 240, the data set can remain un-updated. The data set can also be accessed and read 250.

Generally, a data set can be destroyed. To initiate this process, a data set destroy request is issued 260. While the destroy request is pending 270, a child workflow is spawned 280. If the destroy request is approved, the data set is destroyed 180. If the destroy request is not approved, the data set remains. It should be noted that only a limited number of requests and states are illustrated herein, and that requests beyond the access requests of create, read, update and destroy are considered herein. Further, a number of requests that are further contemplated herein can be classified as one or more of create, read, update, and/or destroy. It should further be noted that while the parent workflow is state machine based, the child workflows can optionally be state machine based or not state machine based.

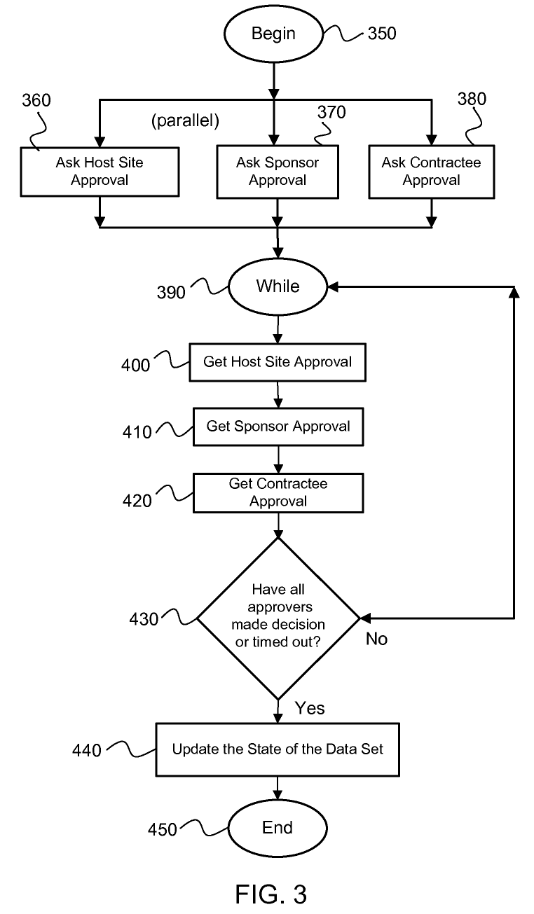

An example child workflow is illustrated as FIG. 3, with human evaluation involved. The child workflow is defined as part of the data policy as well. The workflow includes a beginning point 350, and asks for approval from three people, a person managing the host site 360, represented as “the host site” in FIG. 3, the sponsor 370 who uses the data to conduct web-based advertisement, and contractee 380 who holds the data ownership of the data. While waiting 390 for approval from the noted three, approval is received for each of the host site 400, sponsor 410, and contractee 420. Once all approvers have either expressed an approval decision or timed out 430, the state of the data set can be updated 440, and the workflow can come to an end 450.

There are multiple ways to customize a data policy that involves a state machine workflow. For example, depending on how critical the data set is to the data owner, some states defined in the state machine can be skipped or some child workflows can be removed. In another example, a data owner can choose a particular preferred service provider to implement a piece of the workflow. In another example, a service can attach completely unique policy enforcement workflows to the same types of data sets for different customers. The different customers may have different needs in terms of the sensitivity of the data set. To go further in the example, one organization can use a content management service to store banner ad content having a relatively higher sensitivity, whereas another organization may use the content management service to store customer technical training materials that are of a relatively lower sensitivity.

As a shared service to many service customers, the service can optionally provide different templates regarding policy enforcement workflows, so that customers can choose one of them as a basis to define their own data policies. In one embodiment, a data policy can be captured in a customizable workflow template. As such, customers would need to configure a workflow template with different parameters. For example, with respect to a data quality checking service (which is the service that evaluates the data against some known facts, such as whether data is corrupted, or whether the data is fake, etc.), the chosen service's endpoints and the responsible person's email addresses could be configured in the corresponding workflow template, in order to specify which preferred service gets chosen.

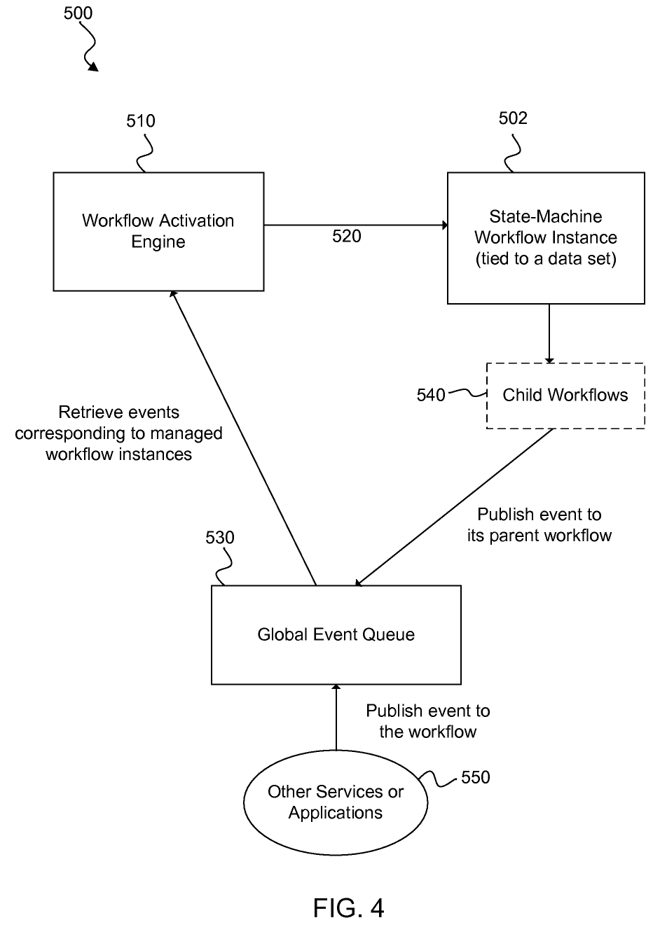

FIG. 4 illustrates overall event interactions in one embodiment. Particularly, the combination of components depicted in FIG. 4 provides a policy enforcer 500. Each state machine workflow 502 (the top-level workflow defined in the data policy) can have a well-defined set of events that are raised from the workflow activation engine 510, such that the active state of the workflow can be changed when the events arrive. An event communication channel 520 between the state machine workflow and the workflow activation engine can be used. The workflow activation engine can hold a collection of state machine workflow instances. The engine can periodically check whether there are pending events in the global event queue 530 that belong to the workflow instance that corresponds to a data set instance. The pending events are then retrieved and sent over the event channel to the corresponding workflow instance. As previously noted, the state machine workflow can spawn child workflows 540 as needed. The events of the child workflows can be published to the parent workflow, and reported to the global event queue. Other services or applications 550 also publish events to the workflow of the global event queue. The events that are published to the global event queue can come from the active workflow instances, web services, applications, or other event sources. In one embodiment, the event queue can be the communication channel for the child workflows to communicate to its parent workflow. Depending on the actual implementation of the workflow activation engine, the event channel between the engine and the managed workflow might not support arbitrary event types. Instead, the channel might only support a predefined set of event types. In that case, one workflow activation engine can be mapped to a set of the state-machine based workflows that share the same set of events.

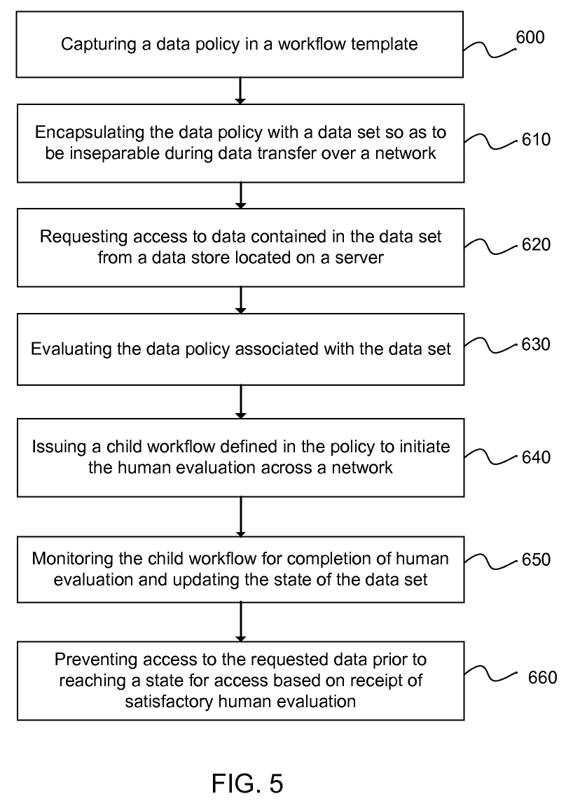

A method for managing data, therefore, can include capturing a data policy in a workflow template, as in block 600, as shown in FIG. 5. As previously discussed, the data policy can include human evaluation. The data policy can be encapsulated with a data set so as to be inseparable during transfer over a network, as in block 610. In one embodiment, the term encapsulated means that a reference to the policy will travel with the data and the policy will be examined by looking up a reference (e.g., a URL) which can save space and communication costs. Alternatively, the entire policy can be sent with the data. It should be noted that in the present context, the term “inseparable” does not necessarily indicate physical or electronic inseparability, but rather indicates that the data set cannot be sent over a network without also sending the associated data policy. The particular mechanics of sending over the network can occur according to any sending mechanisms currently known or later developed, including use of data packets.

The method can further include requesting access to data contained in the data set from a data store located on a server, as in block 620. The data policy associated with the data set can be evaluated, as in block 630, and a child workflow defined in the data policy can be issued to initiate the human evaluation across a network, as in block 640. The child workflow can be monitored for completion of the human evaluation and the state of the data set is updated correspondingly, as in block 650. The method can further include preventing access to the requested data prior to reaching a state for access based on receipt of satisfactory human evaluation, as in block 660. It should be noted that satisfactory human evaluation is subject to the particular request, and should not be construed to require positive responses from the person or people responsible for the human evaluation (e.g. timeout waiting for feedback). Although not shown, in one embodiment, the method can further include allowing access to the requested data following reaching a state for access based on either receipt of satisfactory human evaluation or lack of receipt of unsatisfactory human evaluation.

Non-limiting examples of requested access can include copying, updating, reading, deleting, writing, creating, transferring, executing, and combinations thereof. In one embodiment, the requested data access includes deletion of the data set. In such a case, the method can further include deleting the requested data set following receipt of satisfactory human evaluation.

Thus, a content management service, either as a third-party service, or as an in-house service, can hold documents and multi-media content for multiple organizations in a common content repository. For example, each customer's data can be separated in different file directories. If data is held in databases, for example customer historical purchase information, then individual records that belong to different customers may have different policies associated with them. As the data sets are shared between service providers, the policies associated with those data sets can also be shared.

To better understand the need and application of the presently disclosed system and method, imagine a fictional small business that conducts a sales and marketing campaign using a number of service providers in a service marketplace. Consider the company relying on ten different services. A data mining analytics service identifies the targets for the campaign; a creative agency designs campaign materials including banner ads with text, graphics and video, brochures, and email messages; and a content management service hosts the campaign materials. The campaign is launched through direct mail, email, and banner ads. The direct mail and email services require the business to provide them the customer contact information. The banner ad service is a mediator which sub-contracts to ad providers specializing in social networking, newspaper, and sports. A tracking service gauges effectiveness and fine-tunes the running campaign. Leads generated from the multiple campaign channels are stored in the customer relationship management system of the business, and are used to evaluate the effectiveness of the campaign against specified metrics.

Companies, such as the one described above, can increase operational efficiency by focusing on what they do best and outsourcing non-core aspects of their business. Typically, outsourcing service providers rely on establishing a reputation of trust over long periods of service engagements with customers. In contrast, the system and method described herein allows a service provider to host the information needed for the sales and marketing campaign of the company described above, while providing reliable safe-guards against unwanted viewing, distribution, and/or use of the business information. In essence, the system itself provides a conduit for creating relationships of trust, and a manner to effectively segregate data sets stored on a single or set of data stores.

The example company described has an environment that does not allow for fine-grained centralized control of the marketing process being run by the company. Thus, any workflow followed by the company for marketing requires cooperation of, and participation by, many service providers, some of which may not be visible or known to the company. Thus, the system and method described herein offers mechanisms to share process control information between service providers as well as the actual content related to marketing. In addition, the present system and method offer controls that can be captured in patterns or templates and configured for each customer or data set based on operational constraints and preferences.

Specific issues are faced by the company desiring to participate in the marketing campaign as outlined. Specific areas of concern include data usage control and data quality assurance. In data usage control, a consideration is to assure customers that their data is well managed and protected. Data appropriateness is a concern in data usage control. Is the content appropriate to be hosted and/or used by the service? In the example, the campaign materials are designed by a campaign material creator service and then deposited into the content management service, and subsequently retrieved by the banner ad placement service and distributed to various websites. Each service can have access to inspect data to verify it is appropriate for use in the respective service. For example, banner ads may look very different than those targeted for direct marketing. Ads considered offensive in one country may be appropriate for placement in other countries.

Data retention is also a concern of data appropriateness. For example, consider two situations of the example company, (a) the customer historical purchase information from the example company is released to a data mining analytics service, and (b) the customer contact information from the company is released to a brochure printing and mailing service. In each case, an obligation can be imposed on the data receivers to only retain the data for an agreed period of time. The obligation fulfillment can be checked, including recursive checks throughout all the affected sub-contractors.

Data migration is yet another concern of data appropriateness. Before customer databases that contain sensitive data migrate to other service providers, preventative measures such as conducting background checks and/or data watermarking can be used to reduce the risk of exposing the sensitive data. Furthermore, to enable the data owner to keep track of data propagation across service providers, approval before migration and/or notification mechanisms can be used when the data is migrated.

Data quality assurance is another area of concern. As a data receiver, customers need accurate and authentic data that reflects their running business process and the global business environment that they are in. The example company can utilize the present method and system to check that the click-stream data from its Internet-based marketing campaign through the banner ad placement service, and the sales lead list information returned from the campaign tracking and measurement service are authentic and trustworthy.

A specific data migration example for the fictitious company is as follows: suppose the company outsources its customer relationship management database to an outsourced database service provider. The database contains sensitive business data such as customer lists, and personally identifiable information about the company's customers such as customer names and addresses. As part of the marketing campaign, the company wants records from the database to be migrated to a brochure printing and mailing service. A data migration policy can be attached to the entire database table for this purpose. An example detailed data migration policy can include the following rules:

A. The candidate data receiver must be Safe Harbor certified by the U.S. Commerce Department to meet customer privacy requirements.

B. The database table will go through a watermarking service to produce a unique copy of the database table for this particular data receiver. (This would reduce the risk of data leakage by enabling identification of the service provider that was responsible for any data leak.)

C. The data owner (i.e. the fictitious company described above) must be notified upon completion of migration actions.

D. If the receiving company (i.e. the brochure printing and mailing service) wishes to grant access of any form to any sub-contractors, they must first receive approval of the receiving party as appropriate for the selected data set or sets from (i) the vice-president of the company, and (ii) the quality assurance director of the company.

E. Once the data provider stops using the service provided by the data receiver for any reason, the data receiver must remove the data within two weeks and notify the data provider that the data has been deleted.

A shared service computing environment, such as one maintaining, storing, or otherwise associating a number of different data sets, poses a number of business risks and security threats that include malicious attacks and inadvertent data mishandling. A well-established control process that involves data set management can address these threats. The present method and system address various aspects of data management, including: data appropriateness, data quality, and data retention. Data appropriateness is concerned with verifying that the content of a data set is appropriate to be hosted and/or used by the services. Checking for data appropriateness also prevents inappropriate data sets from being used maliciously or inadvertently, for example, published in public websites or other public-access areas. Further, data appropriateness also verifies the cultural, regional, language, and other aspects related to releasing or using data sets in a public forum. Data quality should be maintained as large quantities of data are hosted, and utilized by one or more sources. Where data is transferred, it should be of the same quality as originally created. When a customer's sensitive data is released, there can be an obligation set in place to cause the data receiver to only retain the data for a short, or defined time period, and under data retention rules, the owner of the data set or sets can be notified when the receiver fulfills the obligation of destroying the data at the expiration of the retention time.

A multi-tenant environment can complicate data resource management. Each organization that owns one or more data sets in the environment can have its own data sensitivity definition. As such, each data set can include unique policies. Customizable policy templates can be utilized to prepare unique policies. Policy enforcement sometimes involves the stakeholders coming from external services, and each customer organization can have its own favorite or preferred services upon which its functionalities are dependent. Furthermore, dynamic organizational interaction structures allow for policy enforcement dependent on actual organizational interaction structures. For example, the approval process for a content management service can potentially involve the organization that owns the service, the service customer, and a sub-contractor of the service customer that contributes the content. As a result, when a sub-contractor is replaced, the approval policy at the service side can change to accommodate the change of the sub-contracting structure dynamically.

In summary, the system and method provide avenues to correctly manage the lifecycle of each data set, from the time the set is created, then retrieved, optionally updated any number of times, and finally destroyed. The state machine based workflow encapsulates policies related to data quality measurement, data retention, and data appropriateness checking; enforces these policies in a timely manner, and orchestrates external services that can involve human evaluation.

Furthermore, then, the present method and system provide a unified state machine based policy framework that is capable of describing various data management policies in the service environment for different lifecycle states at different levels of data granularity. Support for human evaluation (e.g., human decision) in policies is feasible because of the event driven nature of the state machine. Policy is an integrated part of the data. Customers have the power and flexibility to customize the policy based on the templates provided by the service provider. The data-related lifecycle state machine workflow allows per-data instance workflows to be specified and enforced for each tenant of a shared service. And finally, the policy enforcement workflow execution can produce assertion attributes as the result to be attached to the data sets as part of their metadata, to reflect the current states of the data sets. Such assertion attributes can become part of the criteria to grant access rights to the data sets.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A system for managing data, comprising:
a plurality of data sets stored in a data store on a server;
a plurality of data policies, each associated with a single data set, the data policies being captured in a workflow template and encapsulated with the data set, wherein at least one of the data policies uses human evaluation; and
a policy enforcer configured to receive requests for data, interpret the associated data policy, and comply with the human evaluation of the data policies by spawning a child workflow defined in the data policy to initiate the human evaluation across a network.

2. A system as in claim 1, wherein the human evaluation includes review and approval of data.

3. A system as in claim 2, wherein the review and approval is selected from the group consisting of: determining content correctness, appropriateness for a particular usage, approval to migrate data, approval of migration specifications for the data, destruction of data, and combinations thereof.

4. A system as in claim 1, wherein the human evaluation includes approval of receiving party as appropriate for receiving requested data.

5. A system as in claim 1, wherein the human evaluation includes human evaluation by a plurality of individuals.

6. A system as in claim 1, wherein the data sets are stored in the data store on the server controlled by a first party and at least one of the data sets are owned by a second party.

7. A system as in claim 1, wherein the data sets include sensitive business information.

8. A method for managing data, comprising:
capturing a data policy in a workflow template, said data policy using human evaluation;
encapsulating the data policy with a data set so as to be inseparable during data transfer over a network;
requesting access to data contained in the data set from a data store located on a server;
evaluating the data policy associated with the data set;
issuing a child workflow defined in the data policy to initiate the human evaluation across a network;
monitoring the child workflow for completion of human evaluation and updating the state of the data set; and
preventing access to the requested data prior to reaching a state for access based on receipt of satisfactory human evaluation.

9. A method as in claim 8, wherein the satisfactory human evaluation includes review and approval of data.

10. A method as in claim 9, wherein the review and approval of data is selected from the group consisting of: determining content correctness, appropriateness for a particular usage, approval to migrate data, approval of migration specifications for the data, destruction of data, and combinations thereof

11. A method as in claim 8, wherein the satisfactory human evaluation includes approval of receiving party as appropriate for receiving requested data.

12. A method as in claim 8, wherein the human evaluation includes human evaluation by a plurality of individuals.

13. A method as in claim 8, further comprising storing a plurality of data sets having data set-specific data policies in a common data store on a server.

14. A method as in claim 8, wherein the requested access includes access selected from the group consisting of copying, updating, reading, deleting, writing, creating, transferring, executing, and combinations thereof.

15. A method as in claim 8, further comprising allowing access to the requested data following reaching a state for access based on receipt of satisfactory human evaluation.

16. A method as in claim 8, wherein the requested data access includes deletion of the data set, and wherein the method further comprises deleting the requested data set following receipt of satisfactory human evaluation.

17. A method as in claim 8, wherein the data policy is captured in a customizable workflow template.

18. A method for managing data, comprising:
capturing a data policy in a workflow template, said data policy requiring human evaluation from a plurality of individuals;
encapsulating the data policy with a data set so as to be inseparable during data transfer over a network;
storing the encapsulated data policy and data set in a data store with a plurality of data sets each encapsulated with data-set specific data policies, wherein the storing is controlled by a first party;
requesting access to data contained in the data set from the data store located on a server by a second party;
evaluating the data policy associated with the data set;
issuing a child workflow defined in the policy to initiate the human evaluation by a third party across a network, wherein the third party is the owner of the data set;
monitoring the child workflow for completion of human evaluation and updating the state of the data set; and
preventing access to the requested data prior to reaching a state for access based on receipt of satisfactory human evaluation.

19. A method as in claim 18, further comprising approval of data selected from the group consisting of: determining content correctness, appropriateness for a particular usage, approval to migrate data, approval of migration specifications for the data, destruction of data, and combinations thereof.

20. A method as in claim 18, the data policy is captured in a customizable workflow template.
